(19) United States
(12) Patent Application Publication
(10) Pub. No.: US 2001/0001373 A1
(43) Pub. Date: May 24, 2001

(54) Method and apparatus for separating individual blanks from a plurality of sheet metal blanks, and cutting apparatus having blank separating means

(76) Inventors: Peter Schreiber, Ipsach (CH); Felix Van Der Schaar, Wilen (CH)

Correspondence Address: Daniel G. Mackas, McCormick, Paulding & Huber, City Place II, 185 Asylum Street, Hartford, CT, 06103-3402, US

(21) Appl. No.: 09/760,563

(22) Filed: Jan. 16, 2001

Related U.S. Application Data
(62) Division of application No. 09/056,465, filed on Apr. 7, 1998.

(30) Foreign Application Priority Data
Apr. 11, 1997 (CH) 0849/97

(51) Int. Cl. B26D 1/143

(52) U.S. Cl. 83/23; 83/364; 83/370; 83/408

(57) ABSTRACT

In a cutting apparatus for cutting a printed metal sheet (1) into a number of individual sheet metal blanks (A1-A6, B1-B6, C1-C6), a conveyor-path switch (9) for removing blanks with defective printing from the conveyor path is provided for separating each blank chosen at the blank discharge point. The conveyor-path switches are selectively activated by a control unit (6). This enables individual blanks to be discarded, thus reducing machine down time and waste of material due to sheets with defective printing.

The invention relates to a method according to the introductory part of claim 1, an apparatus according to the introductory part of claim 5, and a cutting apparatus according to the introductory part of claim 7.

It is known to cut metal sheets into a plurality of individual blanks, which are used in particular for the fabrication of can bodies. In this case the blanks are rounded and welded in a known manner. Before cutting takes place, the corresponding metal sheets are printed and/or lacquered to give the subsequently formed can the required external finish. However, there must be no printing or lacquer in those regions of the metal sheet which later form the weld margins of the can, otherwise weldability is lost. The cutting up of sheets into blanks is carried out on known cutting apparatus. If the machine operator notices a flaw in the printing and/or lacquering of a sheet, or of a blank which has just been cut, at present the cutting machine is stopped and the affected sheets, strips or blanks are removed by hand. It often happens that several successive sheets are affected. The resulting work is time-consuming and therefore costly, as it causes prolonged stoppage of the cutting apparatus. Furthermore the removal of entire sheets results in unnecessary consumption of material.

Therefore the problem at the basis of the invention is to provide a separation method and an apparatus for separating sheets which do not have the drawbacks which have been described, and, furthermore, to provide a cutting apparatus with means for the separation of unwanted sheet metal strips or blanks.

For the method stated at the outset, this problem is solved by the characterising features of claim 1, and for the separation apparatus stated at the outset it is solved by the characterising features of claim 5. For the cutting apparatus stated at the outset it is solved by the characterising features of claim 7.

If the operator at the control arrangement is able to select any blank within the sheet, and if a controllable conveyor-path switch is operable for each blank, any defective blank can be separated and removed without stopping the operation of the cutting apparatus. Removal of entire sheets becomes unnecessary, and excessive consumption of material is thus avoided.

Ways of carrying out the invention will now be described by way of example with reference to the accompanying drawings, in which:

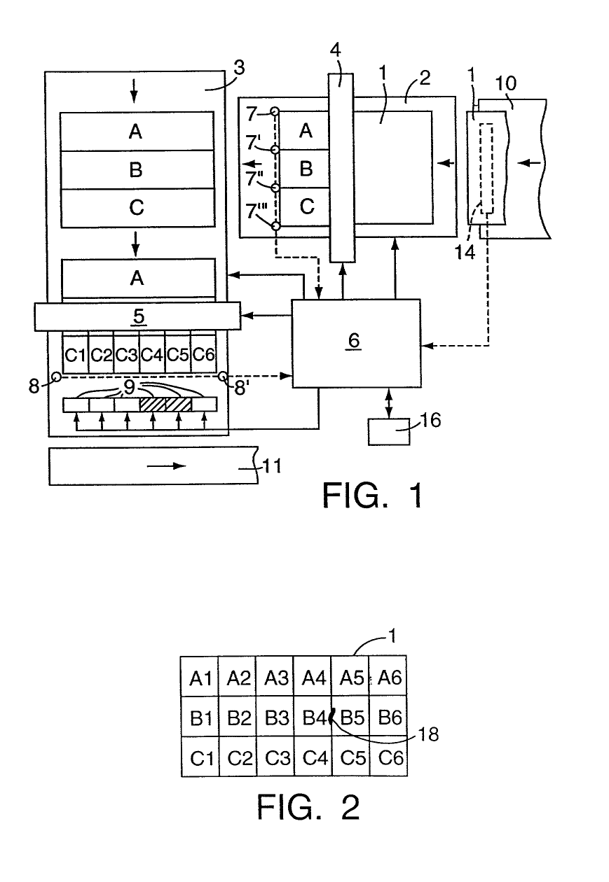

FIG. 1 is a schematic representation of the process of cutting up metal sheets into blanks;

FIG. 2 shows an example of the control panel for the operator; and

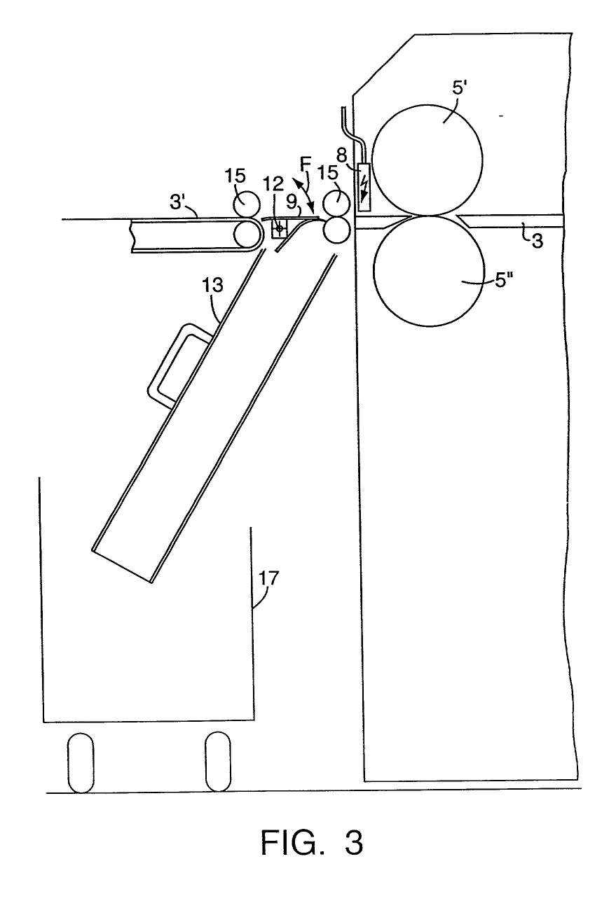

FIG. 3 illustrates one embodiment of a conveyor-path switch.

The invention will now be described with reference to a cutting apparatus in which a particular cutting sequence occurs. The invention can, however, be used with any process for producing sheet metal blanks, such as stamping for example. An apparatus according to the invention can also be set up to operate downstream of any machine producing blanks, if necessary with the interposition of conveying means (of any desired kind) for the blanks.

FIG. 1 shows schematically a shearing machine for cutting metal sheets into a plurality of individual sheet metal blanks. In the illustrated arrangement, in which the sheet metal blanks leave the cutting apparatus in a direction at right angles to the incoming metal sheets, this cutting apparatus is also referred to as an angle shears. Specifically, FIG. 1 shows how the incoming metal sheets 1, which are fed individually on a conveyor arrangement 10 not forming part of the cutting apparatus, are cut into separate strips A, B and C by a first shears arrangement 4.

In the cutting apparatus, the sheets 1 (and thus the strips A, B, C) are fed through the first shears 4 on a conveyor arrangement with a first conveyor means 2. Such shears for dividing the metal sheet 1 into sheet metal strips A, B, C are known, and will not be further described here. The sheet metal strips then pass, within the cutting apparatus, onto a separate second conveyor means 3 which fees them to further shears 5. These are also known and will not be described in detail. In the shears 5 the separate strips A, B, C are cut into a plurality of individual blanks. In FIG. 1 this is shown for the strip C by the blanks C1 C2, C3, C4, C5 and C6. At the point of discharge from the cutting apparatus the individual blanks are received by a further conveyor means 11 which no longer forms part of the cutting apparatus and which transports the blanks for further processing.

A control arrangement 6 controls the conveyor means 2, 3 and also the shears 4, 5. A number of conveyor-path switches 9 are provided at the exit from the cutting apparatus. The number of switches corresponds to the number of blanks cut from each strip. These switches, which are described in more detail below, are also controlled by the control unit 6. Each switch 9 can either allow the blank concerned to pass through en route to the further conveyor means 11, or deflect the blank out of its path to the conveyor means and direct it eg. to a collecting point.

FIG. 2 shows how a metal sheet 1 is divided into the blanks A1-A6, B1-B6 and C1-C6. The input means 16 of the control arrangement 6 for the operator of the cutting apparatus may be provided in this form, eg. by corresponding keys on a control panel, or, preferably, by a corresponding display on a screen which is configured as a touch-sensitive screen so that the operator can effect an input to the control arrangement by touching the screen. FIG. 2 also shows, as a black spot, a flaw in the printing or lacquering of a sheet 1. This flaw is located in those areas of the sheet 1 which would later form the blanks B4 and B5, and the flaw straddles the zone reserved for welding at the margins of the blanks B4 and B5 which must be devoid of printing or lacquering when the blanks are subsequently welded into can bodies.

When the operator observes such a flaw on a sheet 1, he can activate the corresponding fields B4 and B5 on the input arrangement 16 for the control arrangement 6, instructing the control arrangement that the corresponding blanks are to be ejected by the conveyor-path switches. After the metal sheet 1 has been cut into the strips A, B and C and after the strip B is cut again into the blanks B1-B6, the affected conveyor-path switches 9 which are shown hatched in FIG. 1 are actuated by the control arrangement 6 as the corresponding B-blanks are being discharged at the exit from the shearing machine, so that the defective blanks B4 and B5 do not run onto the further conveyor means 11, but instead pass to a collection point for defective blanks which is not shown in FIG. 1.

As a printing flaw of this kind is often repeated on several sheets, the control unit 6 will preferably continue to divert out of the normal conveyor path the same blanks B4 and B5 from ensuing sheets 1. When the operator resets the corresponding input, the affected conveyor-path switches 9 are no longer activated by the control arrangement 6, so that subsequent blanks B4 and B5 resume the normal conveyor path.

Printing flaws can also be detected by sensors arranged above the incoming sheets 1 and can be communicated directly to the control arrangement, so that intervention by an operator is then unnecessary. In FIG. 1 this is indicated schematically by a sensor 14 which is connected to the control arrangement 6. The sensor 14 may be formed eg. by photoelectric cells which monitor the blank unprinted regions on the metal sheet. Alternatively the sensor 14 could be formed by a camera and an image processing unit which checks an image of the sheet 1 for corresponding flaws.

Also indicated in FIG. 1 are known sensors 7 such as have been commonly used hitherto on angle shears. The sensors 7 at the exit from the first shears 4 check whether the edges of the strips A, B, C cut by the shears 4 have been cut correctly. If this is not the case for one of the strips, the whole strip is rejected, or a number of strips are rejected, in a known manner. When the sensor 7 is activated, the strip A, with all its blanks, is rejected. When the sensor 7′ is activated, the strips A and B are rejected. Activation of the sensor 7″ causes strips B and C to be rejected, and activation of the sensor 7″′ causes rejection of strip C. This is known, and will not be further described. However, the sensors 7-7″′ may now be used differently, so that the control unit does not reject the strips A, B, C and their elimination is effected by means of the conveyor-path switches 9. It may suffice to eliminate only individual blanks, and not all the blanks in a strip. This makes it possible to dispense with the strip ejection arrangement, and to achieve a further saving of material.

It is also known to check by means of sensors 8 and 8′ whether the strip which has been divided into blanks has parallel outer edges (the outer edges of the blanks C1 and C6) after passing through the shears 5. If the two sensors indicate that these edges are not parallel, the entire strip (ie. all blanks 1-6) is ejected from the cutting apparatus. This check and ejection procedure is also already known, and will not be further described. Here again, selective ejection can be effected by means of the conveyor-path switches 9, instead of the ejection of all the blanks which has been known hitherto.

FIG. 3 is a side view, partly in section, of one embodiment of the discharge point for the sheet metal blanks. It shows two rotating cutters 5′ and 5″ of the shears arrangement 5, and also the conveyor means 3. The conveyor-path switches 9 are located downstream of the shears arrangement 5. In the illustrated example, these switches are formed by conveyor sections which can be pivoted up and down about the axis 12 in the direction of the arrow F. The pivoting action is triggered eg. electromagnetically or pneumatically, and is controlled by the control arrangement 6, as already stated. In the lower pivot setting shown in FIG. 3, the sheet metal blank leaving the cutter wheels 5′ and 5″ is propelled along a straight path by the rollers 15, and passes onto the next section 3′ of the conveyor. Thus in this setting the sheet metal blank is discharged normally from the shearing machine. When the conveyor-path switch is tilted upwards, after leaving the cutter wheels the blank is deflected downwards into the chute 13 and thence into a collection cart 17. The rejected blanks are thus collected in the cart 17. As already stated, the unit with the conveyor-path switches can be constructed as an independent apparatus which can be set up to operate downstream of any kind of blank-producing machine.

1. Method for separating individual selected sheet metal blanks from a plurality of sheet metal blanks (A1-A6, B1-B6, C1-C6), the blanks being produced in a processing apparatus (2, 3, 4, 5) from successive metal sheet (1), characterised in that one or more of the blanks to be produced from each sheet is or are selected at a control arrangement (6), and that the control arrangement separates the selected blanks in each sheet from the unselected blanks by means of conveyor-path switch means (9) after the blanks are formed.

2. Method according to claim 1, characterised in that the apparatus initially forms sheet metal strips (A, B, C) from each successive sheet (1), the blanks (A1-A6, B1-B6, C1-C6) then being formed from said strips.

3. Method according to claim 1 or claim 2, characterised in that the processing apparatus is a shearing machine.

4. Method according to any one of claims 1 to 3, characterised in that separation is effected in response to signals from sensors (7-7″′; 8, 8′; 14) connected to the control arrangement.

5. Apparatus for separating individual sheet metal blanks from a plurality of sheet metal blanks (A1-A6, B1-B6, C1-C6) which have been produced from a metal sheet (1), characterised by a control arrangement (6) and a conveyor arrangement, the conveyor arrangement being arranged to receive the sheet metal blanks and having for each blank a conveyor-path switch (9) which is operable by the control arrangement, and the control arrangement (6) having an input means (16) by means of which one or more of the blanks (A1-A6, B1-B6, C1-C6) to be produced from the sheets can be selected as a blank to be separated by the corresponding conveyor-path switch.

6. Apparatus according to claim 5, characterised in that the control arrangement (6) has inputs for sensors (7-7″′; 8, 8′; 14) and is configured to separate blanks in response to the sensor output signals.

7. Cutting apparatus for cutting sheet blanks (A1-A6, B1-B6, C1-C6) out of a metal sheet (1) , comprising a first shears arrangement (4) for cutting the sheet (1) into a plurality of strips (A, B, C) and a second shears arrangement (5) for cutting a plurality of blanks from each strip, a conveyor arrangement (2, 3) for conveying sheets, strips and blanks from a metal sheet feed station to the sheet metal blank discharge station, and a control arrangement (6) for the shears arrangements (4, 5) and the conveyor arrangement (2, 3), characterised in that the conveyor arrangement in the region of the sheet metal blank discharge station has a conveyor-path switch (9) which can be operated by the control arrangement in the discharge path of each blank, and that the control arrangement (6) has an input means (16) by means of which one or more of the blanks (A1-A6, B1-B6, C1-C6) to be cut from the sheets can be selected as a blank to be separated by means of the corresponding conveyor-path switch or switches.

8. Cutting apparatus according to claim 7, characterised in that the control arrangement (6) has inputs for sensors (7-7″′; 8, 8′; 14) and is configured to separate blanks in response to the sensor output signals.
